(19) United States
(12) Patent Application Publication
(10) Pub. No.: US 2014/0122546 A1
(43) Pub. Date: May 1, 2014

(54) TUNING FOR DISTRIBUTED DATA STORAGE AND PROCESSING SYSTEMS

(71) Applicants: Guangdeng D. Liao, Hillsboro, OR (US); Nezih Yigitbasi, Delft (NL); Theodore Willke, Tacoma, WA (US); Kushal Datta, Hillsboro, OR (US)

(72) Inventors: Guangdeng D. Liao, Hillsboro, OR (US); Nezih Yigitbasi, Delft (NL); Theodore Willke, Tacoma, WA (US); Kushal Datta, Hillsboro, OR (US)

(21) Appl. No.: 13/663,901

(22) Filed: Oct. 30, 2012

(51) Int. Cl. G06F 17/30

(52) U.S. Cl. 707/827; 707/E17.01

(57) ABSTRACT

The present disclosure describes tuning for distributed data and storage and processing systems. A device may comprise a tuner module configured to determine a distributed data and storage and processing system configuration based at least on configuration information available in the device, and to adjust the distributed data and storage and processing system configuration based on a baseline configuration. The tuner module may be further configured to then determine sample information for the distributed data and storage and processing systems derived from actual distributed data and storage and processing system operation, and to use the sample information in creating a performance model of the distributed data and storage and processing system. The tuner module may be further configured to then evaluate configuration changes to the system based on the performance model, and to determine a recommended distributed data and storage and processing system configuration based on the evaluation.

### TECHNICAL FIELD The present disclosure relates to distributed system optimization, and more particularly, to systems for tuning the configuration of distributed data storage and processing systems.

### BACKGROUND

The virtualization of modern society (e.g., the growing tendency for both personal and business interaction to be conducted over the Internet) has created at least one challenge in how to manage large amounts of information that are being generated from wholly online interaction. The storage space and/or processing requirements needed to support growing online enterprises may almost immediately exceed the abilities of a single machine (e.g., server) and thus, groups of servers may be needed to manage information. Larger enterprises may employ many server racks, with each server rack comprising multiple servers all charged with storing and processing enterprise data. The resulting number of servers to be coordinated may be substantially large.

As solutions sometimes create other problems, how to manage a large number of servers had to be considered to help ensure that information can be processed quickly and stored safely. At least one example of an existing solution that may be utilized to manage a large number of servers is the Hadoop software library produced by the Apache Software Foundation. Hadoop provides a framework allowing for the distributed processing of large amounts of information across clusters (e.g., groups of computers). For example, Hadoop may be configured to assign tasks to servers that are appropriate for handling the task (e.g., that comprise information needed for completing the task). Hadoop may also manage copies of information to ensure that the loss of a server or even a rack does not mean that access to information will be lost. While Hadoop and other similar management solutions may have great potential in their ability to maximize the efficiency of distributed data storage and processing systems, their potential can only be realized through correct configuration. Configuration must currently be conducted manually through a process of continual system “tweaking” by operators with knowledge of the system architecture.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example of a distributed data storage and processing system including a tuner module in accordance with at least one embodiment of the present disclosure;

FIG. 2 illustrates an example configuration for a device on which the tuner module may reside in accordance with at least one embodiment of the present disclosure;

FIG. 3 illustrates a flowchart of example operations for tuning a distributed data storage and processing system in accordance with at least one embodiment of the present disclosure; and

FIG. 4 illustrates examples of information that may be employed in, and/or tasks that may be performed during, the example operations previously disclosed with respect to FIG. 3.

Although the following Detailed Description will proceed with reference being made to illustrative embodiments, many alternatives, modifications and variations thereof will be apparent to those skilled in the art.

### DETAILED DESCRIPTION

This disclosure describes systems and methods pertaining to tuning for distributed data storage and processing systems. Initially, the terms “information” and “data” have been utilized interchangeably throughout this disclosure. A “distributed data storage and processing system” (DDSPS), as referenced herein, may comprise a plurality of devices connected by one or more networks, the plurality of devices being configured to at least one of store data or process data. The plurality of devices may, in certain circumstances, act together to store and/or process data for a job (e.g., for a single data consumer). For example, the plurality of devices may comprise computing devices (e.g., servers) comprising processing resources (e.g., one or more processors) and storage resources (e.g., electromechanical or solid-state storage devices). While structures, terminology, etc. typically associated with Hadoop may be referenced for the sake of explanation herein, the various disclosed embodiments are not intended to be limited to implementation only in a DDSPS employing Hadoop. On the contrary, embodiments may be implemented with any DDSPS management system allowing for functionality consistent with the present disclosure.

In one embodiment, a device may comprise a tuner module. The tuner module may be, for example, embodied partially or wholly as software executable within the device. In general, the tuner module may be configured to perform activities that eventually lead to a recommended configuration for a DDSPS. For example, the tuner module may be configured to determine a DDSPS configuration based at least on configuration information, and to then adjust the DDSPS configuration based on a baseline configuration. The tuner module may be further configured to then determine sample information for the DDSPS derived from actual DDSPS operation, and to use the sample information in creating a performance model of the DDSPS. The tuner module may be further configured to then evaluate configuration changes to the system based on the performance model, and to determine a recommended configuration based on the evaluation.

Determining a configuration for the DDSPS may comprise, for example, determining a system provisioning configuration and a system parameter configuration. In a Hadoop DDSPS (e.g., a DDSPS with at least one Hadoop cluster), the HDSPS configuration may be determined based upon Hadoop distributed file system (HDFS) and Hadoop MapReduce engine configuration files. Adjusting the DDSPS configuration may comprise, for example, adjusting a network configuration, a system configuration or the configuration of at least one device in the DDSPS. When operating upon a Hadoop DDSPS, the tuner module may be configured to determine one or more samples, each of the one or more samples including at least a configuration to run a workload in the Hadoop cluster, a job log corresponding to the workload and resource use information corresponding to the workload. Creating a performance model for the DDSPS may comprise the tuner module being configured to compile a mathematical model of the DDSPS based on the based on the one or more samples, the mathematical model describing at least one of system performance and system dependencies.

The tuner module may be configured to then evaluate the performance model. For example, the tuner module may be further configured to determine the recommended configuration by searching over a configuration space and evaluating possible configurations using the performance model. In one embodiment, upon determining a recommended configuration, the tuner module may also be configured to cause the recommended configuration to be implemented in the DDSPS. In the same or a different embodiment, the tuner module may also be configured to provide a summary including suggested changes needed to change the configuration of the DDSPS into the recommended configuration.

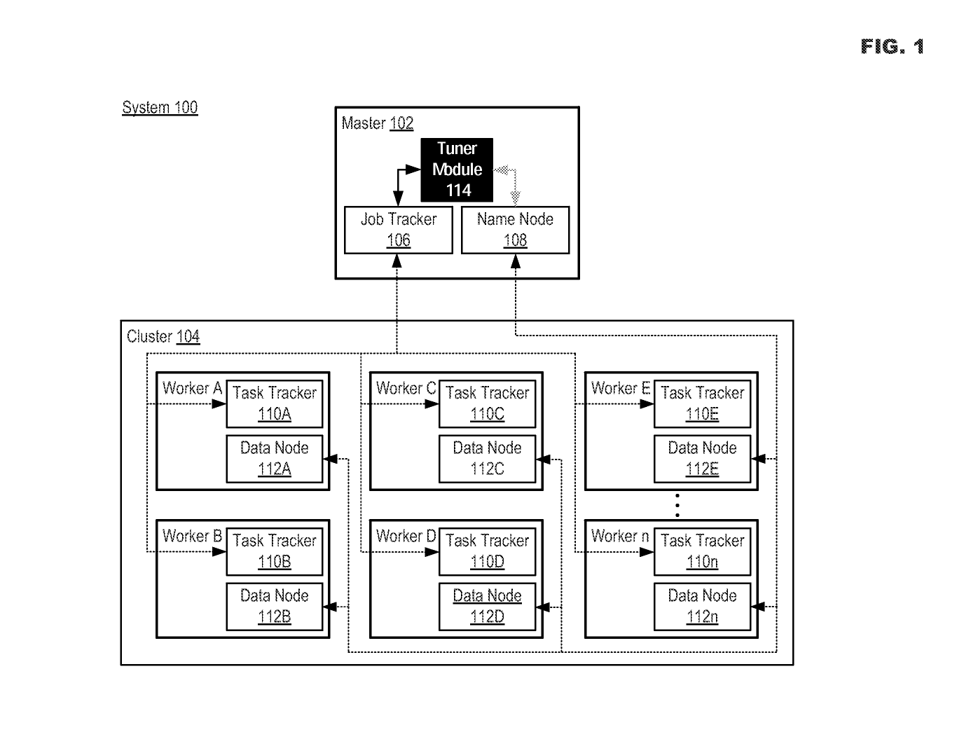

FIG. 1 illustrates example DDSPS 100 including tuner module 114 in accordance with at least one embodiment of the present disclosure. Using terminology commonly associated with Hadoop architecture, DDSPS 100 may comprise, for example, master 102 and HDFS cluster 104. The master may include, for example, job tracker 106, name node 108 and tuner module 114. Each cluster 1 . . . n may include, for example, workers A . . . n, with each worker including a corresponding task tracker 110A . . . n and data node 112A . . . n. An example of a physical layout usable to visualize system 100 is that cluster 104 may comprise one or more server racks, and workers A . . . n correspond to computing devices (e.g., servers) in the one or more server racks.

Master 102 may be configured to manage the configuration of cluster 104 and to also distribute tasks to workers A . . . n in cluster 104. In Hadoop, the data management of cluster 104 may be conducted by HDFS, while distribution of tasks to workers A . . . n in clusters 1 . . . n may be determined by the Hadoop MapReduce engine or job tracker 106. HDFS may be configured to keep track of the information stored on each worker A . . . n. For example, metadata describing the information content of data nodes 112A . . . n may be communicated from data nodes 112A . . . n in workers A . . . n to name node 108 in master 102. Armed with this information, HDFS may not only be aware of where data resides, but may also supervise the replication of data to help ensure continuous data access during server/rack outages. For example, HDFS may prevent copies of the same data from residing in the same server rack to ensure that the data will still be available in DDSPS 100 if the server rack goes down (e.g., due to malfunction, maintenance, etc.). The location and composition of workers A . . . n may also be employed by the MapReduce engine to assign tasks to workers A . . . n. MapReduce may be configured to break jobs into smaller tasks that may be distributed to workers A . . . n for processing. Upon completing each task, workers A . . . n may return the results of each task to the master, where the results may be compiled into the results for the job. For example, job tracker 106 may be configured to schedule jobs to be performed by system 100, and to break the jobs into tasks for task trackers 110A . . . n with the awareness of data location. For example, processing for a task requiring data stored in a data node (e.g., data node 112B) may be assigned to the corresponding server (e.g., worker B), which may cut down on network traffic by eliminating needless data transfers between workers A . . . n.

Tuner module 114 may be configured to tune the configuration of DDSPS 100 based on a combination of configuration information received from DDSPS 100 and modeling based on the actual operation of DDSPS 100. For example, tuner module 114 may be installed in the master to allow access to configuration files for DDSPS 100. In an example where Apache Hadoop has been deployed to manage DDSPS 100, HDFS configuration files and at least job tracker 106 may be accessible to tuner module 114. Optionally, tuner module 114 may be further configured to interact with both job tracker 106 and name node 108. Optional interaction with name node 108 may depend upon, for example, the information needed by tuner module 114 to determine a recommended configuration for DDSPS 100, the manner of implementation of the recommended configuration (e.g., manually or automatically), etc.

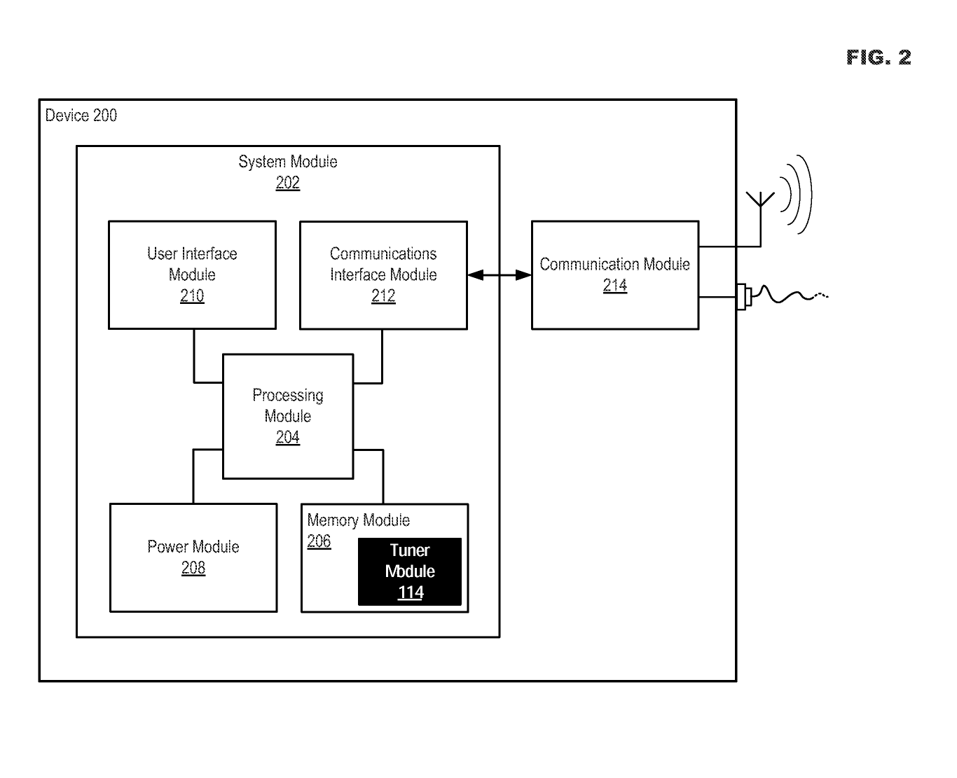

FIG. 2 illustrates an example configuration for a device on which tuner module 114 may reside in accordance with at least one embodiment of the present disclosure. In general terms, device 200 may be any computing device having suitable resources (e.g., processing power and memory) to execute tuner module 114 alongside the management software for DDSPS 100 (e.g., Apache Hadoop). Example devices may include tablet computers, laptop computers, desktop computers, servers, etc. While the master of DDSPS 100 may be made up of multiple devices due to, for example, the resources needed to control a large DDSPS 100, tuner module 114 may reside on only one machine. When Hadoop is employed, this may be the same device wherein at least the HDFS configuration files, MapReduce configuration files and job tracker 106 are installed. Device 200 may comprise, for example, system module 202, which may be configured to manage operations in device 200. System module 202 may include, for example, processing module 204, memory module 206, power module 208, user interface module 210 and communication interface module 212, which may be configured to interact with communication module 214. In the illustrated embodiment, tuner module 114 is represented as being composed primarily of software residing in memory module 206. However, the various embodiments disclosed herein are not limited only to this implementation, and may include implementations wherein tuner module 114 comprises both hardware and software elements. Further, communication module 214 being shown outside system module 200 is merely for the sake of explanation herein. Some or all of the functionality associated with communication module 214 may also be incorporated into system module 202.

In device 200, processing module 204 may comprise one or more processors situated in separate components, or alternatively, may comprise one or more processing cores embodied in a single component (e.g., in a System-on-a-Chip (SOC) configuration) and any processor-related support circuitry (e.g., bridging interfaces, etc.). Example processors may include various x86-based microprocessors available from the Intel Corporation including those in the Pentium, Xeon, Itanium, Celeron, Atom, Core i-series product families. Examples of support circuitry may include chipsets (e.g., Northbridge, Southbridge, etc. available from the Intel Corporation) configured to provide an interface through which processing module 204 may interact with other system components that may be operating at different speeds, on different buses, etc. in device 200. Some or all of the functionality commonly associated with the support circuitry may also be included in the same physical package as the processor (e.g., an SOC package like the Sandy Bridge integrated circuit available from the Intel Corporation). In one embodiment, processing module 204 may be equipped with virtualization technology (e.g., VT-x technology available in some processors and chipsets available from the Intel Corporation) allowing for the execution of multiple virtual machines (VM) on a single hardware platform. For example, VT-x technology may also incorporate trusted execution technology (TXT) configured to reinforce software-based protection with a hardware-enforced measured launch environment (MLE).

Processing module 204 may be configured to execute instructions in device 200. Instructions may include program code configured to cause processing module 204 to perform activities related to reading data, writing data, processing data, formulating data, converting data, transforming data, etc. Information (e.g., instructions, data, etc.) may be stored in memory module 206. Memory module 206 may comprise random access memory (RAM) or read-only memory (ROM) in a fixed or removable format. RAM may include memory configured to hold information during the operation of device 200 such as, for example, static RAM (SRAM) or

Dynamic RAM (DRAM). ROM may include memories such as bios memory configured to provide instructions when device 200 activates, programmable memories such as electronic programmable ROMs (EPROMS), Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 208 may include internal power sources (e.g., a battery) and/or external power sources (e.g., electromechanical or solar generator, power grid, etc.), and related circuitry configured to supply device 200 with the power needed to operate.

User interface module 210 may include circuitry configured to allow users to interact with device 200 such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 212 may be configured to handle packet routing and other control functions for communication module 214, which may include resources configured to support wired and/or wireless communications. Wired communications may include serial and parallel wired mediums such as, for example, Ethernet, Universal Serial Bus (USB), Firewire, Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, WLAN, Wi-Fi, etc.) and long range wireless mediums (e.g., cellular, satellite, etc.). In one embodiment, communication interface module 212 may be configured to prevent wireless communications that are active in communication module 214 from interfering with each other. In performing this function, communication interface module 212 may schedule activities for communication module 214 based on, for example, the relative priority of messages awaiting transmission.

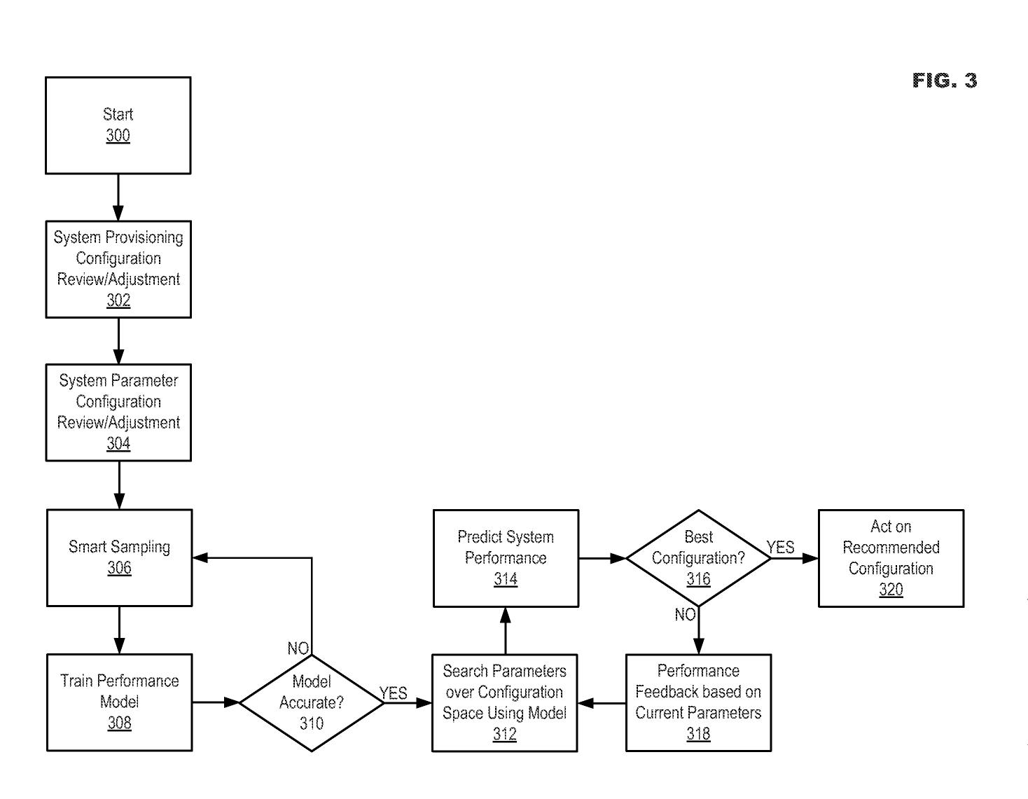

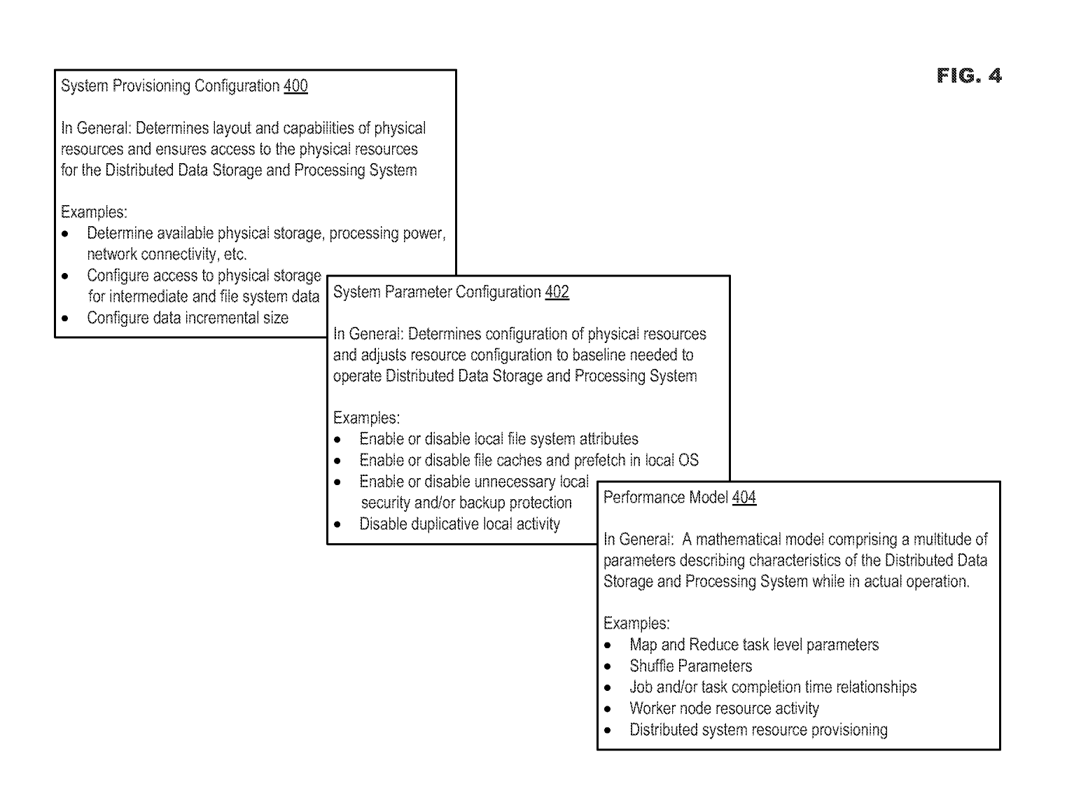

During the course of operation, tuner module 114 may interact with some or all of the modules described above with respect to device 200. For example, tuner module 114 may, in some instances, employ communication module 214 in communicating with other devices in DDSPS 100. Communication with other devices in DDSPS 100 may occur to, for example, obtain configuration information for DDSPS 100, determine provisioning in DDSPS 100, implement a recommended configuration for DDSPS 100, etc. In one embodiment, tuner module 114 may also be configured to interact with user interface module 210 to, for example, summarize the changes needed to implement the recommended configuration in DDSPS 100. FIG. 3 illustrates a flowchart of example operations for tuning DDSPS 100 in accordance with at least one embodiment of the present disclosure. Following startup in operation 300, tuner module 114 may be configured to initially review the configuration of DDSPS 100 in operations 302 and 304. In one embodiment, configuration may be broken into a provisioning configuration and a parameter configuration. In operation 302, the provisioning configuration of DDSPS 100 may be reviewed and reconfigured, if necessary. As illustrated at 400 in FIG. 4, the provisioning configuration may be based on the physical composition of DDSPS 100 including, for example, the devices (e.g., servers) in DDSPS 100, the capabilities (e.g., processing, storage, etc.) of each device, the location of each device (e.g., building, rack, etc.) and the capabilities of the network linking the devices (e.g., throughput, stability, etc.) Based on this information, tuner module 114 may reconfigure DDSPS 100 to, for example, take advantage of devices having more processing power or more abundant storage resources, to organize resources operating in certain locations (e.g., the same rack) to leverage processing/storage resources, to minimize the load that needs to be conducted through slower network links, slower devices, etc. For example, a device having a powerful multicore processor and lower capacity solid-state drives may be used to process time-sensitive transactions, while a device with a less power processor and a large capacity magnetic disk drive might be used for warehousing large amounts of information. Examples of particular changes that may be made may include, for example, configuring the storage location of Hadoop intermediate data and HDFS data for DDSPS 100, configuring incremental data sizes (e.g., Java

Virtual Machine (JVM) heap size for systems based on the Java programming language like Hadoop), configuring fault tolerance (e.g., locations where data will be replicated to avoid the data becoming unavailable, the degree to which data should be replicated, etc.)

In operation 304, tuner module 114 may evaluate the parameter configuration of DDSPS 100. In reviewing the parameter configuration, tuner module 114 may be configured to access configuration files for both DDSPS 100 and the devices making up DDSPS 100. Tuner module 114 may then evaluate the parameter configuration of both against a “baseline” configuration for DDSPS 100, and may reconfigure various parameters in DDSPS 100 accordingly. Baseline, as referred to herein, may comprise preferred network- level configurations, preferred system-level configurations, preferred device-level configurations, etc. that may be required just to operate

DDSPS 100 (e.g., in a substantially error-free state). For example, the baseline configuration for DDSPS 100 may be dictated by the provider of the management software (e.g., Apache Hadoop). As shown at 402 in FIG. 4, examples of parameters that may be evaluated and/or reconfigured by tuner module 114 may include, for example, enabling or disabling of file system attributes in one or more devices within DDSPS 100 (e.g., wherein “local” signifies device-level configuration), enabling or disabling file caches and prefetch in local operating systems (OS), enabling or disabling unnecessary local security and/or backup protection, disabling duplicative local activity, etc. For example, following the evaluation of parameters in DDSPS 100, tuner module 114 may disable security measures that would prevent management software for DDSPS 100 from accessing storage resources in the devices making up DDSPS 100, disable any local access configurations that could delay the transfer of information between the devices, and to disable any localized failure protection (e.g., server RAID systems) because the management system for DDSPS 100 may include similar protection (e.g., Hadoop supports data replication in disparate locations within DDSPS 100).

After the initial configuration phase, tuner module 114 may be configured to determine a performance model based on sample information derived from the operation of DDSPS 100, and to determine a recommended configuration for DDSPS 100 based on searching over a configuration space using the performance model. As referenced herein, searching over a configuration space may comprise, for example, first determining all of the possible parameter configurations for the performance model (e.g., determining the configuration space) and then “searching over” the configuration space by trying various parameter combinations (e.g., based on an optimization algorithm) to determine how the system will perform as compared to previous system configurations. At least one advantage that may be realized from drawing samples from actual operation is that tuner module 114 may perform tuning during the normal operation of DDSPS 100. For example, in instances where tuner module 114 is configured to automatically implement a recommended configuration for DDSPS 100, tuning may be performed continually in a manner transparent to the operators of DDSPS 100. Determination of a performance model may include collecting sample information in operation 306, wherein the sample information may include one or more samples derived from DDSPS 100. In an instance where Hadoop is being employed to manage DDSPS 100, each sample may include, for example, a configuration to run a workload in DDSPS 100, a job log corresponding to the workload (e.g., obtained from job log files associated with job tracker 102), resource use information corresponding to the workload, etc. The configuration/parameter space of DDSPS 100 may be quite large, so in at least one embodiment samples may be selected using “smart” sampling. Smart sampling may include using a direct search algorithm based on, for example, genetic algorithms, simulated annealing, simplex methods, gradient descent, recursive random sampling, etc. to intelligently collect samples (e.g., sets of workload information as described above) over a parameter space. Selecting certain samples (e.g., that best reflect the normal operation of DDSPS 100) may reduce the total number of samples needed to accurately represent the operational behavior of DDSPS 100.

In one embodiment, the performance model may be a machine learning model that may be trained in operation 308 based on the samples collected in operation 306. For example, the performance model may be a mathematical model including configurable parameters that may emulate the performance of DDSPS 100. Formulation of the performance model may result from, for example, inputting the samples taken from DDSPS 100 in operation 306 into a supervised machine learning algorithm, which may be configured to effectively model non-linear interaction/dependency amongst different parameters. Example supervised machine learning algorithms may include artificial neural networks (ANNs), M5 decision tree, support vector regression (SVR), etc. The performance model may describe the system performance of DDSPS 100 using various parameters. As shown at 404 in FIG. 4, example parameters that may pertain to DDSPS 100 when being managed by Hadoop may include, for example, Map and Reduce task level parameters, Shuffle parameters, job and/or task completion time relationships, worker node resource activity and distributed system (e.g., DDSPS 100) resource provisioning. In operation 310, sampling and training may continue until a performance model results that has the requisite accuracy in emulating the performance of DDSPS 100. Accuracy may be verified by, for example, inserting the parameters of a workload into the performance model and determining whether the performance model's prediction of performance is close enough (e.g., within an allowed error) to actual results observed in the samples taken from DDSPS 100.

After the performance model has been trained in operations 308 and 310, tuner module 114 may be configured to search possible configuration changes to DDSPS 100 using the performance model, with an ultimate goal of arriving at a recommended configuration for DDSPS 100. In operation 312, tuner module 114 may employ an optimization search algorithm to search the configuration space and test configuration using the performance model to determine a best configuration for DDSPS 100. For example, in operations 316 and 318 tuner module 114 may be configured to select parameter configurations based on the optimization algorithm, and to test the parameter configuration's performance using the model. The performance of the parameter configuration may be compared to previous configurations to determine whether the performance of DDSPS 100 would improve as a result of the changes. The search algorithm may consider, for example, system performance issues (e.g., relationships, bottlenecks, dependencies, etc.), in determining parameter configurations that may be implemented to alleviate the performance issues.

If a best configuration is achieved in operation 318, then in operation 320 tuner module 114 may act on the recommended configuration. In one embodiment, tuner module 114 may be configured to automatically implement the recommended configuration in DDSPS 100. Automatically implementing the recommended configuration may include, for example, causing the management software in DDSPS 100 (e.g., Apache Hadoop) to implement changes to arrive at the recommended configuration. This may occur by tuner module 114 altering or updating information in the HDFS and MapReduce configuration files, communicating with specific devices in DDSPS 100 to change local configurations, communicating with network devices to change network configurations, etc. In the same or a different embodiment, tuner module 114 may also be configured to summarize suggested changes to the configuration of DDSPS 100 to implement the recommended configuration. For example, tuner module 114 may not be able to cause some or all of the recommended reconfiguration to be implemented automatically, and may instead summarize the needed changes in, for example, a report format (e.g., may display the report or provide it for printing to paper. The report may indicate, for example, portions of DDSPS 100 to be reconfigured, and possibly the procedure for making these changes to DDSPS 100. Alone, or in combination with reconfiguration suggestions, the report may also identify particular devices, network equipment, etc. as bottlenecks in DDSPS 100, and may recommend the upgrade or replacement of the problematic devices, network equipment, etc.

While FIG. 3 illustrates various operations according to an embodiment, it is to be understood that not all of the operations depicted in FIG. 3 are necessary for other embodiments. Indeed, it is fully contemplated herein that in other embodiments of the present disclosure, the operations depicted in FIG. 3, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure describes tuning for distributed data and storage and processing systems. A device may comprise a tuner module configured to determine a distributed data and storage and processing system configuration based at least on configuration information available in the device, and to adjust the distributed data and storage and processing system configuration based on a baseline configuration. The tuner module may be further configured to then determine sample information for the distributed data and storage and processing systems derived from actual distributed data and storage and processing system operation, and to use the sample information in creating a performance model of the distributed data and storage and processing system. The tuner module may be further configured to then evaluate configuration changes to the system based on the performance model, and to determine a recommended distributed data and storage and processing system configuration based on the evaluation.

The following examples pertain to further embodiments. In one example embodiment there is provided a device. The device may include at least a tuner module configured to determine a configuration for a distributed data storage and processing system based at least on configuration information, adjust the configuration of the distributed data storage and processing system based on a baseline distributed data storage and processing system configuration, determine sample information for the distributed data storage and processing system, the sample information being derived from operation of the distributed data storage and processing system, create a performance model of the distributed data storage and processing system based on the sample information, evaluate configuration changes to the distributed data storage and processing system using the performance model; and determine a recommended configuration based on the configuration change evaluation.

The above example device may be further configured, wherein the tuner module comprises a software component, the device further comprising at least one processor configured to execute program code stored within a memory in the device, the execution of the program code generating the software component.

The above example device may be further configured, alone or in addition to the above example configurations, wherein the tuner module being configured to determine the configuration for the distributed data storage and processing system comprises the tuner module being configured to determine a system provisioning configuration and a system parameter configuration for the distributed data storage and processing system.

The above example device may be further configured, alone or in addition to the above example configurations, wherein the tuner module being configured to adjust the configuration of the distributed data storage and processing system comprises the tuner module being configured to adjust at least one of a network configuration, a system configuration or a configuration of at least one device in the distributed data storage and processing system.

The above example device may be further configured, alone or in addition to the above example configurations, wherein the distributed data storage and processing system comprises at least one Hadoop cluster and the tuner module being configured to determine sample information comprises the tuner module being configured to access at least job log files corresponding the at least one Hadoop cluster, the job log files being available in the device. In this configuration, the example device may be further configured, wherein the sample information comprises one or more samples, each sample including at least a configuration to run a workload in the at least one Hadoop cluster, a job log corresponding to the workload and resource use information corresponding to the workload. In this configuration, the example device may be further configured, wherein the tuner module being configured to create a performance model of the distributed data storage and processing system comprises the tuner module being configured to compile a mathematical model of the distributed data storage and processing system based on the one or more samples, the mathematical model describing at least one of system performance and system dependencies.

The above example device may be further configured, alone or in addition to the above example configurations, wherein the tuner module being configured to evaluate configuration changes to the distributed data storage and processing system comprises the tuner module being configured to optimize system performance by searching over a configuration space and evaluating configurations using the performance model to determine the recommended configuration.

The above example device may further comprise, alone or in addition to the above example configurations, the tuner module being configured to cause the recommended configuration to be implemented in the distributed data storage and processing system.

The above example device may further comprise, alone or in addition to the above example configurations, the tuner module being configured to provide a summary including suggested changes needed to change the configuration of the distributed data storage and processing system into the recommended configuration.

In another example embodiment there is provided a method. The method may include determining a configuration for a distributed data storage and processing system based at least on configuration information, adjusting the configuration of the distributed data storage and processing system based on a baseline distributed data storage and processing system configuration, determining sample information for the distributed data storage and processing system, the sample information being derived from operation of the distributed data storage and processing system, creating a performance model of the distributed data storage and processing system based on the sample information, evaluating configuration changes to the distributed data storage and processing system using the performance model, and determining a recommended configuration based on the configuration change evaluation.

The above example method may be further configured, wherein determining the configuration for the distributed data storage and processing system comprises determining a system provisioning configuration and a system parameter configuration for the distributed data storage and processing system.

The above example method may be further configured, alone or in addition to the above example configurations, wherein adjusting the configuration of the distributed data storage and processing system comprises adjusting at least one of a network configuration, a system configuration or a configuration of at least one device in the distributed data storage and processing system.

The above example method may be further configured, alone or in addition to the above example configurations, wherein the distributed data storage and processing system comprises at least one Hadoop cluster and determining sample information comprises accessing at least job log files corresponding the at least one Hadoop cluster. In this configuration, the example method may be further configured, wherein the sample information comprises one or more samples, each sample including at least a configuration to run a workload in the at least one Hadoop cluster, a job log corresponding to the workload and resource use information corresponding to the workload. In this configuration, the example method may be further configured, wherein creating a performance model of the distributed data storage and processing system comprises compiling a mathematical model of the distributed data storage and processing system based on the one or more samples, the mathematical model describing at least one of system performance and system dependencies.

The above example method may be further configured, alone or in addition to the above example configurations, wherein evaluating configuration changes to the distributed data storage and processing system comprises optimizing system performance by searching over a configuration space and evaluating configurations using the performance model to determine the recommended configuration.

The above example method may further comprise, alone or in addition to the above example configurations, causing the recommended configuration to be implemented in the distributed data storage and processing system.

The above example method may further comprise, alone or in addition to the above example configurations, providing a summary including suggested changes needed to change the configuration of the distributed data storage and processing system into the recommended configuration.

In another example embodiment there is provided a system including a device comprising at least a tuner module, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided a device configured for tuning distributed data storage and processing systems arranged to perform any of the above example methods.

In another example embodiment there is provided a device having means to perform any of the above example methods.

In another example embodiment there is provided a system comprising at least one machine-readable storage medium having stored thereon individually or in combination, instructions that when executed by one or more processors result in the system carrying out any of the above example methods.

In another example embodiment there is provided a device. The device may include at least a tuner module configured to determine a configuration for a distributed data storage and processing system based at least on configuration information, adjust the configuration of the distributed data storage and processing system based on a baseline distributed data storage and processing system configuration, determine sample information for the distributed data storage and processing system, the sample information being derived from operation of the distributed data storage and processing system, create a performance model of the distributed data storage and processing system based on the sample information, evaluate configuration changes to the distributed data storage and processing system using the performance model, and determine a recommended configuration based on the configuration change evaluation.

The above example device may be further configured, wherein the distributed data storage and processing system comprises at least one Hadoop cluster and the tuner module being configured to determine sample information comprises the tuner module being configured to access at least job log files corresponding the at least one Hadoop cluster, the job log files being available in the device. In this configuration the example device may be further configured, wherein the sample information comprises one or more samples, each sample including at least a configuration to run a workload in the at least one Hadoop cluster, a job log corresponding to the workload and resource use information corresponding to the workload. In this configuration the example device may be further configured, wherein the tuner module being configured to create a performance model of the distributed data storage and processing system comprises the tuner module being configured to compile a mathematical model of the distributed data storage and processing system based on the one or more samples, the mathematical model describing at least one of system performance and system dependencies.

The above example device may be further configured, alone or in addition to the above example configurations, wherein the tuner module being configured to evaluate configuration changes to the distributed data storage and processing system comprises the tuner module being configured to optimize system performance by searching over a configuration space and evaluating configurations using the performance model to determine the recommended configuration.

The above example device may further comprise, alone or in addition to the above example configurations, the tuner module being configured to at least one of cause the recommended configuration to be implemented in the distributed data storage and processing system or provide a summary including suggested changes needed to change the configuration of the distributed data storage and processing system into the recommended configuration.

In another example embodiment there is provided a method. The method may include determining a configuration for a distributed data storage and processing system based at least on configuration information, adjusting the configuration of the distributed data storage and processing system based on a baseline distributed data storage and processing system configuration, determining sample information for the distributed data storage and processing system, the sample information being derived from operation of the distributed data storage and processing system, creating a performance model of the distributed data storage and processing system based on the sample information, evaluating configuration changes to the distributed data storage and processing system using the performance model, and determining a recommended configuration based on the configuration change evaluation.

The above example method may be further configured, wherein the distributed data storage and processing system comprises at least one Hadoop cluster and determining sample information comprises accessing at least job log files corresponding the at least one Hadoop cluster. In this configuration the example method may be further configured, wherein the sample information comprises one or more samples, each sample including at least a configuration to run a workload in the at least one Hadoop cluster, a job log corresponding to the workload and resource use information corresponding to the workload. In this configuration the example method may be further configured, wherein creating a performance model of the distributed data storage and processing system comprises compiling a mathematical model of the distributed data storage and processing system based on the one or more samples, the mathematical model describing at least one of system performance and system dependencies.

The above example method may be further configured, alone or in addition to the above example configurations, wherein evaluating configuration changes to the distributed data storage and processing system comprises optimizing system performance by searching over a configuration space and evaluating configurations using the performance model to determine the recommended configuration.

The above example method may be further comprise, alone or in addition to the above example configurations, at least one of causing the recommended configuration to be implemented in the distributed data storage and processing system or providing a summary including suggested changes needed to change the configuration of the distributed data storage and processing system into the recommended configuration.

In another example embodiment there is provided a system including a device comprising at least a tuner module, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided a device. The device may include at least a tuner module configured to determine a configuration for a distributed data storage and processing system based at least on configuration information, adjust the configuration of the distributed data storage and processing system based on a baseline distributed data storage and processing system configuration, determine sample information for the distributed data storage and processing system, the sample information being derived from operation of the distributed data storage and processing system, create a performance model of the distributed data storage and processing system based on the sample information, evaluate configuration changes to the distributed data storage and processing system using the performance model; and determine a recommended configuration based on the configuration change evaluation.

The above example device may be further configured, wherein the tuner module comprises a software component, the device further comprising at least one processor configured to execute program code stored within a memory in the device, the execution of the program code generating the software component.

The above example device may be further configured, alone or in addition to the above example configurations, wherein the tuner module being configured to determine the configuration for the distributed data storage and processing system comprises the tuner module being configured to determine a system provisioning configuration and a system parameter configuration for the distributed data storage and processing system.

The above example device may be further configured, alone or in addition to the above example configurations, wherein the tuner module being configured to adjust the configuration of the distributed data storage and processing system comprises the tuner module being configured to adjust at least one of a network configuration, a system configuration or a configuration of at least one device in the distributed data storage and processing system.

The above example device may be further configured, alone or in addition to the above example configurations, wherein the distributed data storage and processing system comprises at least one Hadoop cluster and the tuner module being configured to determine sample information comprises the tuner module being configured to access at least job log files corresponding the at least one Hadoop cluster, the job log files being available in the device. In this configuration, the example device may be further configured, wherein the sample information comprises one or more samples, each sample including at least a configuration to run a workload in the at least one Hadoop cluster, a job log corresponding to the workload and resource use information corresponding to the workload. In this configuration, the example device may be further configured, wherein the tuner module being configured to create a performance model of the distributed data storage and processing system comprises the tuner module being configured to compile a mathematical model of the distributed data storage and processing system based on the one or more samples, the mathematical model describing at least one of system performance and system dependencies.

The above example device may be further configured, alone or in addition to the above example configurations, wherein the tuner module being configured to evaluate configuration changes to the distributed data storage and processing system comprises the tuner module being configured to optimize system performance by searching over a configuration space and evaluating configurations using the performance model to determine the recommended configuration.

The above example device may further comprise, alone or in addition to the above example configurations, the tuner module being configured to cause the recommended configuration to be implemented in the distributed data storage and processing system.

The above example device may further comprise, alone or in addition to the above example configurations, the tuner module being configured to provide a summary including suggested changes needed to change the configuration of the distributed data storage and processing system into the recommended configuration.

In another example embodiment there is provided a method. The method may include determining a configuration for a distributed data storage and processing system based at least on configuration information, adjusting the configuration of the distributed data storage and processing system based on a baseline distributed data storage and processing system configuration, determining sample information for the distributed data storage and processing system, the sample information being derived from operation of the distributed data storage and processing system, creating a performance model of the distributed data storage and processing system based on the sample information, evaluating configuration changes to the distributed data storage and processing system using the performance model, and determining a recommended configuration based on the configuration change evaluation.

The above example method may be further configured, wherein determining the configuration for the distributed data storage and processing system comprises determining a system provisioning configuration and a system parameter configuration for the distributed data storage and processing system.

The above example method may be further configured, alone or in addition to the above example configurations, wherein adjusting the configuration of the distributed data storage and processing system comprises adjusting at least one of a network configuration, a system configuration or a configuration of at least one device in the distributed data storage and processing system.

The above example method may be further configured, alone or in addition to the above example configurations, wherein the distributed data storage and processing system comprises at least one Hadoop cluster and determining sample information comprises accessing at least job log files corresponding the at least one Hadoop cluster. In this configuration, the example method may be further configured, wherein the sample information comprises one or more samples, each sample including at least a configuration to run a workload in the at least one Hadoop cluster, a job log corresponding to the workload and resource use information corresponding to the workload. In this configuration, the example method may be further configured, wherein creating a performance model of the distributed data storage and processing system comprises compiling a mathematical model of the distributed data storage and processing system based on the one or more samples, the mathematical model describing at least one of system performance and system dependencies.

The above example method may be further configured, alone or in addition to the above example configurations, wherein evaluating configuration changes to the distributed data storage and processing system comprises optimizing system performance by searching over a configuration space and evaluating configurations using the performance model to determine the recommended configuration.

The above example method may further comprise, alone or in addition to the above example configurations, causing the recommended configuration to be implemented in the distributed data storage and processing system.

The above example method may further comprise, alone or in addition to the above example configurations, providing a summary including suggested changes needed to change the configuration of the distributed data storage and processing system into the recommended configuration.

In another example embodiment there is provided a system. The system may include means for determining a configuration for a distributed data storage and processing system based at least on configuration information, means for adjusting the configuration of the distributed data storage and processing system based on a baseline distributed data storage and processing system configuration, means for determining sample information for the distributed data storage and processing system, the sample information being derived from operation of the distributed data storage and processing system, means for creating a performance model of the distributed data storage and processing system based on the sample information, means for evaluating configuration changes to the distributed data storage and processing system using the performance model, and means for determining a recommended configuration based on the configuration change evaluation.

The above example system may be further configured, wherein determining the configuration for the distributed data storage and processing system comprises determining a system provisioning configuration and a system parameter configuration for the distributed data storage and processing system.

The above example system may be further configured, alone or in addition to the above example configurations, wherein adjusting the configuration of the distributed data storage and processing system comprises adjusting at least one of a network configuration, a system configuration or a configuration of at least one device in the distributed data storage and processing system.

The above example system may be further configured, alone or in addition to the above example configurations, wherein the distributed data storage and processing system comprises at least one Hadoop cluster and determining sample information comprises accessing at least job log files corresponding the at least one Hadoop cluster. In this configuration the example system may be further configured, wherein the sample information comprises one or more samples, each sample including at least a configuration to run a workload in the at least one Hadoop cluster, a job log corresponding to the workload and resource use information corresponding to the workload. In this configuration the example system may be further configured, wherein creating a performance model of the distributed data storage and processing system comprises compiling a mathematical model of the distributed data storage and processing system based on the one or more samples, the mathematical model describing at least one of system performance and system dependencies.

The above example system may be further configured, alone or in addition to the above example configurations, wherein evaluating configuration changes to the distributed data storage and processing system comprises optimizing system performance by searching over a configuration space and evaluating configurations using the performance model to determine the recommended configuration.

The above example system may further comprise, alone or in addition to the above example configurations, means for causing the recommended configuration to be implemented in the distributed data storage and processing system.

The above example system may further comprise, alone or in addition to the above example configurations, means for providing a summary including suggested changes needed to change the configuration of the distributed data storage and processing system into the recommended configuration.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device, comprising:
at least a tuner module configured to:
determine a configuration for a distributed data storage and processing system based at least on configuration information;
adjust the configuration of the distributed data storage and processing system based on a baseline distributed data storage and processing system configuration;
determine sample information for the distributed data storage and processing system, the sample information being derived from operation of the distributed data storage and processing system;
create a performance model of the distributed data storage and processing system based on the sample information;
evaluate configuration changes to the distributed data storage and processing system using the performance model; and
determine a recommended configuration based on the configuration change evaluation.

2. The device of claim 1, wherein the tuner module comprises a software component, the device further comprising at least one processor configured to execute program code stored within a memory in the device, the execution of the program code generating the software component.

3. The device of claim 1, wherein the tuner module being configured to determine the configuration for the distributed data storage and processing system comprises the tuner module being configured to determine a system provisioning configuration and a system parameter configuration for the distributed data storage and processing system.

4. The device of claim 1, wherein the tuner module being configured to adjust the configuration of the distributed data storage and processing system comprises the tuner module being configured to adjust at least one of a network configuration, a system configuration or a configuration of at least one device in the distributed data storage and processing system.

5. The device of claim 1, wherein the distributed data storage and processing system comprises at least one Hadoop cluster and the tuner module being configured to determine sample information comprises the tuner module being configured to access at least job log files corresponding the at least one Hadoop cluster, the job log files being available in the device.

6. The device of claim 5, wherein the sample information comprises one or more samples, each sample including at least a configuration to run a workload in the at least one Hadoop cluster, a job log corresponding to the workload and resource use information corresponding to the workload.

7. The device of claim 6, wherein the tuner module being configured to create a performance model of the distributed data storage and processing system comprises the tuner module being configured to compile a mathematical model of the distributed data storage and processing system based on the one or more samples, the mathematical model describing at least one of system performance and system dependencies.

8. The device of claim 1, wherein the tuner module being configured to evaluate configuration changes to the distributed data storage and processing system comprises the tuner module being configured to optimize system performance by searching over a configuration space and evaluating configurations using the performance model to determine the recommended configuration.

9. The device of claim 1, further comprising the tuner module being configured to cause the recommended configuration to be implemented in the distributed data storage and processing system.

10. The device of claim 1, further comprising the tuner module being configured to provide a summary including suggested changes needed to change the configuration of the distributed data storage and processing system into the recommended configuration.

11. A method, comprising:
determining a configuration for a distributed data storage and processing system based at least on configuration information;
adjusting the configuration of the distributed data storage and processing system based on a baseline distributed data storage and processing system configuration;
determining sample information for the distributed data storage and processing system, the sample information being derived from operation of the distributed data storage and processing system;
creating a performance model of the distributed data storage and processing system based on the sample information;
evaluating configuration changes to the distributed data storage and processing system using the performance model; and
determining a recommended configuration based on the configuration change evaluation.

12. The method of claim 11, wherein determining the configuration for the distributed data storage and processing system comprises determining a system provisioning configuration and a system parameter configuration for the distributed data storage and processing system.

13. The method of claim 11, wherein adjusting the configuration of the distributed data storage and processing system comprises adjusting at least one of a network configuration, a system configuration or a configuration of at least one device in the distributed data storage and processing system.

14. The method of claim 11, wherein the distributed data storage and processing system comprises at least one Hadoop cluster and determining sample information comprises accessing at least job log files corresponding the at least one Hadoop cluster.

15. The method of claim 14, wherein the sample information comprises one or more samples, each sample including at least a configuration to run a workload in the at least one Hadoop cluster, a job log corresponding to the workload and resource use information corresponding to the workload.

16. The method of claim 15, wherein creating a performance model of the distributed data storage and processing system comprises compiling a mathematical model of the distributed data storage and processing system based on the one or more samples, the mathematical model describing at least one of system performance and system dependencies.

17. The method of claim 11, wherein evaluating configuration changes to the distributed data storage and processing system comprises optimizing system performance by searching over a configuration space and evaluating configurations using the performance model to determine the recommended configuration.

18. The method of claim 11, further comprising causing the recommended configuration to be implemented in the distributed data storage and processing system.

19. The method of claim 11, further comprising providing a summary including suggested changes needed to change the configuration of the distributed data storage and processing system into the recommended configuration.

20. At least one machine-readable storage medium having stored thereon, individually or in combination, instructions that when executed by one or more processors result in the following operations comprising:
determining a configuration for a distributed data storage and processing system based at least on configuration information;
adjusting the configuration of the distributed data storage and processing system based on a baseline distributed data storage and processing system configuration;
determining sample information for the distributed data storage and processing system, the sample information being derived from operation of the distributed data storage and processing system;
creating a performance model of the distributed data storage and processing system based on the sample information;
evaluating configuration changes to the distributed data storage and processing system using the performance model; and
determining a recommended configuration based on the configuration change evaluation.

21. The medium of claim 20, wherein determining the configuration for the distributed data storage and processing system comprises determining a system provisioning configuration and a system parameter configuration for the distributed data storage and processing system.

22. The medium of claim 20, wherein adjusting the configuration of the distributed data storage and processing system comprises adjusting at least one of a network configuration, a system configuration or a configuration of at least one device in the distributed data storage and processing system.

23. The medium of claim 20, wherein the distributed data storage and processing system comprises at least one Hadoop cluster and determining sample information comprises accessing at least job log files corresponding the at least one Hadoop cluster.

24. The medium of claim 23, wherein the sample information comprises one or more samples, each sample including at least a configuration to run a workload in the at least one Hadoop cluster, a job log corresponding to the workload and resource use information corresponding to the workload.

25. The medium of claim 24, wherein creating a performance model of the distributed data storage and processing system comprises compiling a mathematical model of the distributed data storage and processing system based on the one or more samples, the mathematical model describing at least one of system performance and system dependencies.

26. The medium of claim 20, wherein evaluating configuration changes to the distributed data storage and processing system comprises optimizing system performance by searching over a configuration space and evaluating configurations using the performance model to determine the recommended configuration.

27. The medium of claim 20, further comprising instructions that when executed by one or more processors result in the following operations comprising:
causing the recommended configuration to be implemented in the distributed data storage and processing system.

28. The medium of claim 20, further comprising instructions that when executed by one or more processors result in the following operations comprising:
providing a summary including suggested changes needed to change the configuration of the distributed data storage and processing system into the recommended configuration.
